(19) United States
(12) Patent Application Publication
(10) Pub. No.: US 2023/0261905 A1
(43) Pub. Date: Aug. 17, 2023

(54) USER EQUIPMENT, BASE STATION, AND CHANNEL ESTIMATION AND FEEDBACK SYSTEM FOR USER EQUIPMENT AND BASE STATION

(71) Applicant: NTT DOCOMO, INC., Tokyo (JP)

(72) Inventors: Xin Wang, Beijing (CN); Xiaolin Hou, Beijing (CN); Anxin Li, Beijing (CN); Lan Chen, Beijing (CN); Tong Chen, Beijing (CN); Jiajia Guo, Beijing (CN); Shi Jin, Beijing (CN)

(73) Assignee: NTT DOCOMO, INC., Tokyo (JP)

(21) Appl. No.: 18/002,416

(22) PCT Filed: Apr. 9, 2021
(86) PCT No.: PCT/CN2021/086192

§ 371 Date: Dec. 19, 2022

(30) Foreign Application Priority Data
Jun. 19, 2020 (CN) 202010568941.0

(51) Int. Cl. H04L 25/02; H04L 1/00

(52) U.S. Cl. CPC H04L 25/0224; H04L 1/0026

(57) ABSTRACT

A user equipment, a base station, a joint training device for a user equipment and a base station, a joint channel estimation and feedback system for a user equipment and a base station, a feedback channel state information generation method, a channel matrix generation method, a joint training method, and a joint channel estimation and feedback method for a user equipment and a base station in wireless communication. Feedback channel state information is generated by a user equipment according to an actual pilot signal, and a deeper residual learning neural network is introduced into a base station to reconstruct a channel matrix of the base station according to the feedback channel state information. As such, it is possible that the base station can reconstruct a complete high-resolution channel matrix even if an actually received pilot signal is an incomplete low-resolution part.

### TECHNICAL FIELD

The present disclosure relates to the field of wireless communication, and particularly relates to a user equipment, a base station, a joint training device of the user equipment and the base station, a joint channel estimation and feedback system of the user equipment and the base station, a feedback channel state information generation method executed by the user equipment, a channel matrix generation method executed by the base station, a joint training method of the user equipment and the base station, and a joint channel estimation and feedback method for the user equipment and the base station.

### BACKGROUND

Large-scale multiple-input multiple-output (MIMO) system is one of the key technologies of 5G wireless communication, which can greatly increase the throughput of wireless communication system by configuring a large number of antennas at the base station and forming multiple independent channels in the spatial domain. Large-scale MIMO system requires that the base station can accurately know the channel state information, and use it to eliminate the interference among multi-users through precoding. It is one of the commonly used channel state acquisition methods for the user to measure the downlink channel state information and feed it back to the base station. Considering that the base station uses a large number of antennas, the feedback of complete channel state information will lead to huge resource overhead.

Therefore, it is necessary to provide a channel estimation and feedback method that can compress the channel state information with high compression rate and quickly and accurately reconstruct the channel state information from the feedback information with high compression rate. Under the assumption that the user equipment receives the ideal complete channel state information, the user equipment uses the feedback signal generated by the complete channel state information, and the base station uses the feedback signal to reconstruct the ideal complete channel matrix. However, in the actual MIMO system, the actual pilot signal received by the user equipment is usually an incomplete low-resolution part. If the user equipment performs channel estimation and feedback based on the actual low-resolution pilot signal, it will be difficult for the base station to reconstruct the complete channel matrix according to the feedback signal.

### SUMMARY

The present disclosure has been made in view of the above problems. The invention discloses a user equipment, a base station, a joint training device of the user equipment and the base station, a joint channel estimation and feedback system of the user equipment and the base station, a feedback channel state information generation method executed by the user equipment, a channel matrix generation method executed by the base station, a joint training method of the user equipment and the base station, and a joint channel estimation and feedback method for the user equipment and the base station.

According to an aspect of the present disclosure, a user equipment is provided, which includes a receiving unit for receiving downlink transmission data including a pilot signal from a base station; an encoding unit for encoding the pilot signal into feedback channel state information; and a transmitting unit for transmitting the feedback channel state information to the base station, and for the base station to reconstruct the channel matrix of the base station based on the feedback channel state information.

The user equipment according to an aspect of the present disclosure, wherein the pilot signal is a pilot signal whose frequency is controlled by the base station.

The user equipment according to an aspect of the present disclosure, wherein the coding unit is configured with an encoding neural network, and the encoding neural network includes at least one full connection layer for quantizing and compressing the pilot signal into a one-dimensional vector as the feedback channel state information.

According to another aspect of the present disclosure, a base station is provided, which includes a transmitting unit for transmitting downlink transmission data including pilot signals to user equipment; a receiving unit for receiving uplink transmission data from a user equipment, wherein the uplink transmission data includes feedback channel state information generated based on the pilot signal; and the decoding unit for decoding the feedback channel state information to obtain the channel matrix of the base station.

The base station according to another aspect of the present disclosure, wherein the transmitting unit controls the frequency of the pilot signal.

The base station according to another aspect of the present disclosure, wherein the decoding unit is configured with a decoding neural network, and the decoding neural network at least comprises a multilayer residual convolution neural network, and is used for super-resolution reconstruction of the feedback channel state information into the channel matrix of the base station.

According to another aspect of the present disclosure, there is provided a joint training device of a user equipment and a base station, comprising a receiving unit for receiving a pilot signal and a training pilot signal from the base station; a training unit, which encodes the pilot signal into feedback channel state information by at least encoding neural network, and decodes the feedback channel state information by at least decoding neural network to reconstruct the channel matrix of the base station, acquires a training channel matrix based on the training pilot signal, constructs a loss function based on the channel matrix and the training channel matrix to jointly train the encoding neural network and the decoding neural network, and outputs the parameters of the encoding neural network and the decoding neural network.

According to another aspect of the present disclosure, there is provided a joint channel estimation and feedback system including a user equipment and a base station, including: the user equipment for receiving downlink transmission data including a pilot signal from the base station, encoding the pilot signal into feedback channel state information, and transmitting the feedback channel state information to the base station; and the base station transmits downlink transmission data including pilot signals to user equipment and receives uplink transmission data from user equipment, wherein the uplink transmission data includes feedback channel state information generated based on the pilot signals; and decodes the feedback channel state information to obtain the channel matrix of the base station.

According to another aspect of the present disclosure, there is provided a feedback channel state information generation method executed by a user equipment, which includes: receiving downlink transmission data including a pilot signal from a base station; encoding the pilot signal into feedback channel state information; and transmitting the feedback channel state information to the base station for reconstructing the channel matrix of the base station by the base station based on the feedback channel state information.

According to another aspect of the present disclosure, there is provided a channel matrix generation method executed by a base station, which includes: transmitting downlink transmission data including pilot signals to user equipment; receiving uplink transmission data from a user equipment, wherein the uplink transmission data comprises feedback channel state information generated based on the pilot signal; and decoding the feedback channel state information to obtain the channel matrix of the base station.

According to another aspect of the present disclosure, there is provided a joint training method of user equipment and a base station, which includes: receiving a pilot signal and a training pilot signal from the base station; encoding the pilot signal into feedback channel state information by at least encoding neural network, decoding the feedback channel state information by at least decoding neural network to reconstruct the channel matrix of the base station, obtaining a training channel matrix based on the training pilot signal, constructing a loss function based on the channel matrix and the training channel matrix, and jointly training the encoding neural network and the decoding neural network; and outputting the parameters of the encoding neural network and the decoding neural network.

According to another aspect of the present disclosure, there is provided a joint channel estimation and feedback method for user equipment and base station, which includes: the base station transmits downlink transmission data including pilot signals to the user equipment; the user equipment encodes the pilot signal into feedback channel state information, and transmits the feedback channel state information to the base station; and the base station receives uplink transmission data from the user equipment, wherein the uplink transmission data includes the feedback channel state information generated based on the pilot signal; the base station decodes the feedback channel state information to obtain the channel matrix of the base station.

As will be described in detail below, according to the present disclosure, user equipment, base station, joint training equipment of user equipment and base station, joint channel estimation and feedback system of user equipment and base station, feedback channel state information generation method performed by user equipment, channel matrix generation method performed by base station, joint training method of user equipment and base station and joint channel estimation and feedback method for user equipment and base station, the feedback channel state information is generated by the user equipment according to the actual pilot signal, and a deeper residual learning neural network is introduced into the base station to reconstruct the channel matrix of the base station according to the feedback channel state information. It is realized that the base station can reconstruct the completed high-resolution channel matrix even if the actually accepted pilot signal is an incomplete low-resolution part.

It is to be understood that both the foregoing general description and the following detailed description are exemplary and are intended to provide further explanation of the claimed technology.

### BRIEF DESCRIPTION OF THE DRAWINGS

The above and other objects, features and advantages of the present disclosure will become more apparent by describing the embodiments of the present disclosure in more detail with reference to the accompanying drawings. The accompanying drawings are used to provide a further understanding of the embodiments of the present disclosure, and form a part of the specification. Together with the embodiments of the present disclosure, they serve to explain the present disclosure, and do not constitute a limitation on the present disclosure. In the drawings, the same reference numerals generally represent the same parts or steps.

FIG. 1 is a schematic diagram outlining an application scenario of a wireless communication system according to an embodiment of the present disclosure;

FIG. 2 is a block diagram illustrating a user equipment according to an embodiment of the present disclosure;

FIGS. 3A and 3B are schematic diagrams illustrating pilot signals according to an embodiment of the present disclosure;

FIG. 4 is a flowchart illustrating a feedback channel state information generation method executed by a user equipment according to an embodiment of the present disclosure;

FIG. 5 is a block diagram illustrating a base station according to an embodiment of the present disclosure;

FIG. 6 is a flowchart illustrating a channel matrix generation method executed by a base station according to an embodiment of the present disclosure;

FIG. 7 is a block diagram illustrating a joint channel estimation and feedback system according to an embodiment of the present disclosure;

FIG. 8 is a flowchart illustrating a joint channel estimation and feedback method for a user equipment and a base station according to an embodiment of the present disclosure;

FIG. 9 is a block diagram illustrating a training device and its training joint channel estimation and feedback system according to an embodiment of the present disclosure;

FIG. 10 is a flowchart illustrating a joint training method of a user equipment and a base station according to an embodiment of the present disclosure; and

FIG. 11 is a schematic diagram of the hardware structure of a device related to an embodiment of the present disclosure.

### DETAILED DESCRIPTION OF THE EMBODIMENTS

In order to make the objects, technical solutions and advantages of the present disclosure more obvious, exemplary embodiments according to the present disclosure will be described in detail below with reference to the accompanying drawings. Obviously, the described embodiments are only part of the embodiments of this disclosure, not all of them. It should be understood that this disclosure is not limited by the example embodiments described here.

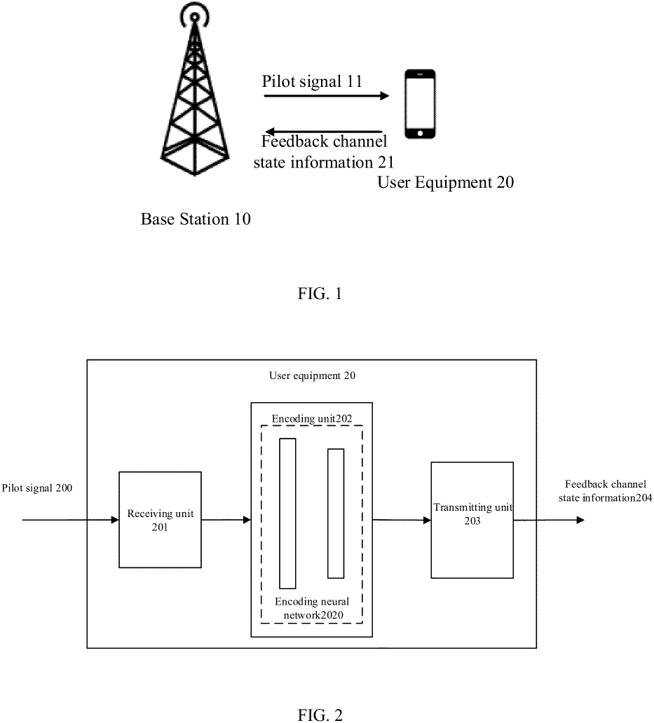

FIG. 1 is a schematic diagram of a wireless communication system in which embodiments of the present disclosure can be applied. The wireless communication system may be a 5G system or any other type of wireless communication system, such as a Long Term Evolution, LTE) system or an LTE-A(advanced) system.

As shown in FIG. 1, a wireless communication system may include a base station 10 and a user equipment 20, and the base station 10 is a serving base station of the user equipment 20. The base station 10 can transmit signals to the user equipment 20, and accordingly, the user equipment 20 can receive signals from the base station 10. In addition, the user equipment 20 may transmit signals (e.g., feedback) to the base station 10, and accordingly, the base station 10 may receive signals from the user equipment 20. The user 20 can configure a signal processor (e.g., a signal encoder) supporting artificial intelligence to process the signal transmitted to the base station 10 through artificial intelligence. Accordingly, the base station 10 may configure a signal processor (e.g., signal decoder) supporting artificial intelligence corresponding to the user equipment 20, so as to process signals received from the user equipment 20 through artificial intelligence.

It should be recognized that although only one base station and one user equipment are shown in FIG. 1, this is only schematic, and the wireless communication system may include multiple base stations and/or multiple user equipments. Accordingly, the wireless communication system may include a plurality of cells. In addition, in this disclosure, the cell and the base station are sometimes used interchangeably.

As shown in FIG. 1, the base station 10 can transmit downlink transmission data to the user equipment 20 on the downlink channel. As will be described in detail below, in the embodiment of the present disclosure, the downlink transmission data may include a reference signal, such as a pilot signal 11. Based on the pilot signal 11, the user 20 transmits feedback channel state information 21 to the base station 10 on the uplink channel. The base station 10 will reconstruct the current channel matrix based on the feedback channel state information 21 fed back by the user equipment 20, so as to optimally configure the downlink channel.

It should be noted that the “reference signal” here can be, for example, a reference signal (RS) on a downlink control channel, traffic data on a downlink data channel and/or a demodulation reference signal (DMRS). In case that the base station is configured with RS and the RS configuration is available, the base station can transmit RS on the downlink control channel. The downlink control channel here may be, for example, a physical downlink control channel (PDCCH), a physical broadcast channel (PBCH), a physical control format indicator channel (PCFICH), etc. The reference signal here may be a channel state information reference signal (CSI-RS), a primary synchronization signal (PSS)/ a secondary synchronization signal (SSS), DMRS or a synchronized signal block (SSB), etc. The feedback channel state information may be a channel state information reference signal (CSI), reference signal receiving power (RSRP), reference signal receiving quality (RSRQ), signal to interference plus noise ratio (SINR), or synchronization signal block index (SSB-index). Taking CSI as an example, CSI may include a channel quality indicator (CQI), a precoding matrix indicator (PMI), a rank indication (RI), channel direction information (CDI), a channel feature vector, or CSI-RS indicator (CRI), etc.

Hereinafter, the base station and user equipment according to the embodiments of the present disclosure, and the joint channel estimation and feedback system implemented by them will be described in further detail.

FIG. 2 is a block diagram illustrating a user equipment according to an embodiment of the present disclosure. As shown in FIG. 2, the user equipment 20 according to the embodiment of the present disclosure includes a receiving unit 201, an encoding unit 202 and a transmitting unit 203.

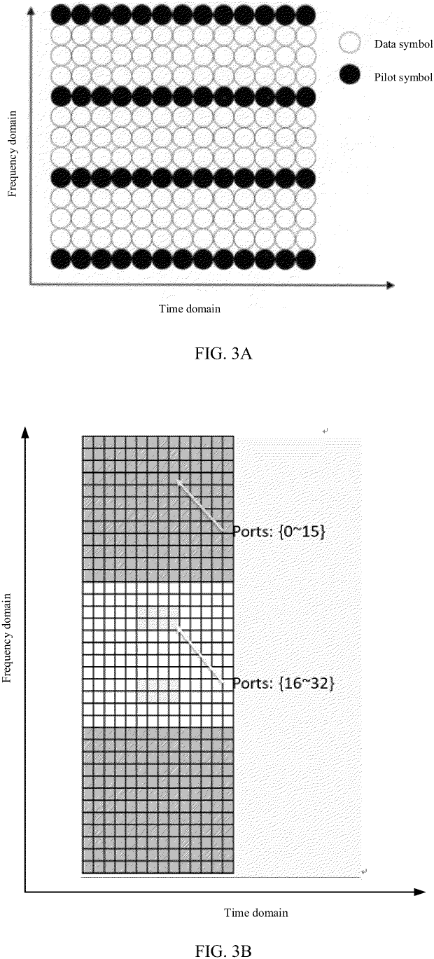

The receiving unit 201 is configured to receive downlink transmission data including a pilot signal 200 from a base station. FIGS. 3 is a schematic diagram illustrating a pilot signal according to an embodiment of the present disclosure. As shown in FIG. 3A, in a possible fast fading environment, pilot symbols are inserted at specific sub-carrier positions in the frequency domain at equal intervals, so that there are pilots on specific sub-carriers in an OFDM symbol, and then the channel changes can be tracked in time. That is, the pilot signal 200 is a pilot signal whose frequency is controlled by the base station 10.

It is easy to understand that the pilot signal according to the embodiment of the present disclosure is not limited to the comb pilot signal shown in FIG. 3A. FIG. 3B shows another example pilot signal according to an embodiment of the present disclosure. As shown in FIG. 3B, in specific NR RS ports (ports 0-15 and 16-32), pilot signals are transmitted according to a predetermined transmission and multiplexing method.

The encoding unit 202 is used to encode the pilot signal 200 into feedback channel state information 204. In an actual wireless communication system, the pilot signal 200 received by the receiving unit 201 is usually a low-resolution part of the whole reference signal. Since the pilot signal 200 is an incomplete reference signal, the feedback channel state information 204 generated by the encoding unit 202 will also be incomplete channel state information (CSI).

In the embodiment of the present disclosure, the coding unit 202 is configured with an encoding neural network 2020, and the encoding neural network 2020 includes at least one full connection layer for quantizing and compressing the pilot signal 200 into a one-dimensional vector as the feedback channel state information. By configuring only one full connection layer, the processing complexity of user equipment will be reduced. In addition to the full connection layer, the encoding neural network 2020 may also include other convolution layers for performing quantization, compression, encoding and modulation on the pilot signal 200.

The transmitting unit 203 is configured to transmit the feedback channel state information 204 to the base station 10, and the base station 10 reconstructs the channel matrix of the base station based on the feedback channel state information 204. As will be described in detail below, the base station 10 according to the embodiment of the present disclosure reconstructs a complete channel matrix with super-resolution network recovery based on the incomplete feedback channel state information 204.

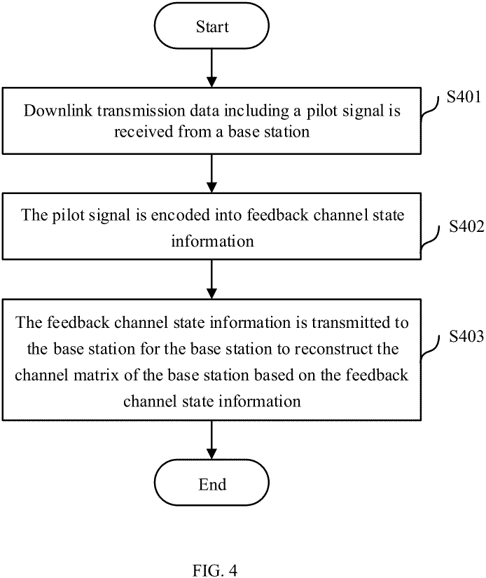

FIG. 4 is a flowchart illustrating a feedback channel state information generation method executed by a user equipment according to an embodiment of the present disclosure. As shown in FIG. 4, the feedback channel state information generation method executed by the user equipment according to the embodiment of the present disclosure includes the following steps.

In step S401, downlink transmission data including a pilot signal is received from a base station. Thereafter, the process proceeds to step S402.

In step S402, the pilot signal is encoded into feedback channel state information. Thereafter, the process proceeds to step S403.

In step S403, the feedback channel state information is transmitted to the base station for the base station to reconstruct the channel matrix of the base station based on the feedback channel state information.

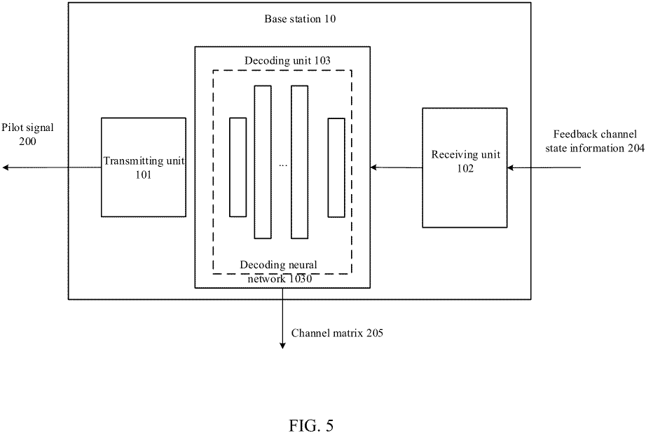

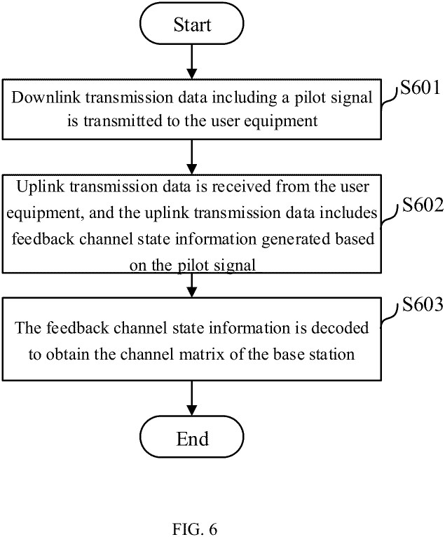

FIG. 5 is a block diagram illustrating a base station implemented according to the present disclosure. As shown in FIG. 5, the base station 10 according to the embodiment of the present disclosure includes a transmitting unit 101, a receiving unit 102, and a decoding unit 103.

The transmitting unit 101 is configured to transmit downlink transmission data including the pilot signal 200 to the user equipment 20. The pilot signal 200 is a pilot signal whose frequency is controlled by the base station 10. For example, in a possible fast fading environment, pilot symbols are inserted at certain sub-carrier positions in the frequency domain at equal intervals, so that there are pilots on certain sub-carriers in an OFDM symbol, and then the channel changes can be tracked in time.

The receiving unit 102 is configured to receive uplink transmission data from the user equipment 20, and the uplink transmission data includes feedback channel state information 204 generated based on the pilot signal 200. As described above with reference to FIGS. 2 and 4, the user equipment 20 encodes the pilot signal 200 as an incomplete reference signal into feedback channel state information 204 as incomplete channel state information (CSI).

The decoding unit 103 is configured to decode the feedback channel state information 204 to obtain the channel matrix 205 of the base station. The decoding unit 103 is configured with a decoding neural network 1030, which at least includes a multilayer residual convolution neural network, and is used for super-resolution reconstruction of the feedback channel state information 204 into the channel matrix 205 of the base station 10. For example, the decoding neural network 1030 includes a full connection layer, a recombination layer and a multi-layer residual convolution neural network. The multilayer residual convolution neural network is, for example, a 16-layer multilayer residual convolution neural network. The base station 10 reconstructs the complete channel matrix through the super-resolution of multi-layer residual convolution neural network.

FIG. 6 is a flowchart illustrating a channel matrix generation method executed by a base station according to an embodiment of the present disclosure. As shown in FIG. 6, the channel matrix generation method executed by the base station according to the embodiment of the present disclosure includes the following steps.

In step S601, downlink transmission data including a pilot signal is transmitted to the user equipment. Thereafter, the process proceeds to step S602.

In step S602, uplink transmission data is received from the user equipment, and the uplink transmission data includes feedback channel state information generated based on the pilot signal. Thereafter, the process proceeds to step S603.

In step S603, the feedback channel state information is decoded to obtain the channel matrix of the base station.

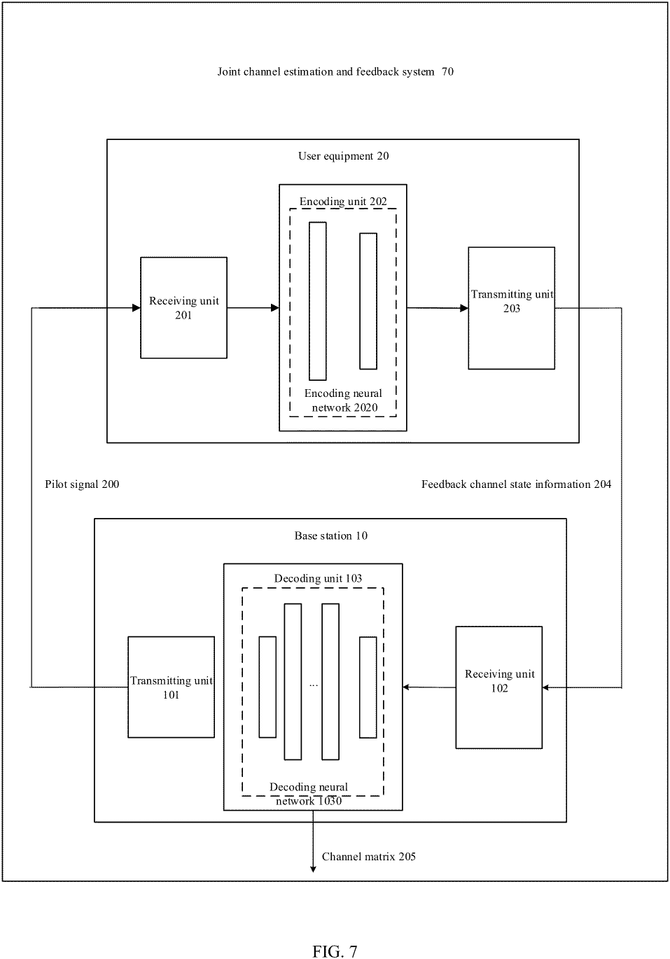

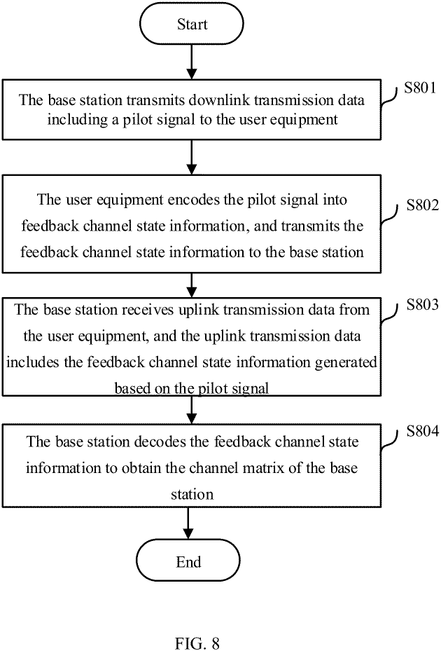

Above, the base station and the user equipment according to the embodiments of the present disclosure are described, respectively. Hereinafter, a joint channel estimation and feedback system and a joint channel estimation and feedback method for a user equipment and a base station according to embodiments of the present disclosure will be further described. FIG. 7 is a block diagram illustrating a joint channel estimation and feedback system according to an embodiment of the present disclosure; FIG. 8 is a flowchart illustrating a joint channel estimation and feedback method for a user equipment and a base station according to an embodiment of the present disclosure.

As shown in FIG. 7, a joint channel estimation and feedback system 70 according to an embodiment of the present disclosure includes a base station 10 and a user equipment 20. The base station 10 and the user equipment 20 are as described above with reference to FIGS. 2 and 5. The base station 10 according to the embodiment of the present disclosure includes a transmitting unit 101, a receiving unit 102, and a decoding unit 103. The user equipment 20 according to the embodiment of the present disclosure includes a receiving unit 201, an encoding unit 202, and a transmitting unit 203.

The transmitting unit 101 of the base station 10 transmits downlink transmission data including the pilot signal 200 to the user equipment 20. The pilot signal 200 is a pilot signal whose frequency is controlled by the base station 10.

The receiving unit 201 of the user equipment 20 is configured to receive downlink transmission data including the pilot signal 200 from the base station.

The encoding unit 202 of the user equipment 20 encodes the pilot signal 200 into feedback channel state information 204. In an actual wireless communication system, the pilot signal 200 received by the receiving unit 201 is usually a low-resolution part of the whole reference signal. Since the pilot signal 200 is an incomplete reference signal, the feedback channel state information 204 generated by the coding unit 202 will also be incomplete channel state information (CSI).

The transmitting unit 203 of the user equipment 20 transmits the feedback channel state information 204 to the base station 10, and the base station 10 reconstructs the channel matrix of the base station based on the feedback channel state information 204.

The receiving unit 102 of the base station 10 receives uplink transmission data from the user equipment 20, and the uplink transmission data includes feedback channel state information 204 generated based on the pilot signal 200.

The decoding unit 103 of the base station 10 decodes the feedback channel state information 204 to obtain the channel matrix 205 of the base station. The decoding unit 103 is configured with a decoding neural network 1030, which at least includes a multilayer residual convolution neural network, and is used for super-resolution reconstruction of the feedback channel state information 204 into the channel matrix 205 of the base station 10. For example, the decoding neural network 1030 includes a full connection layer, a recombination layer and a multi-layer residual convolution neural network. The multilayer residual convolution neural network is, for example, a 16-layer multilayer residual convolution neural network. The base station 10 reconstructs the complete channel matrix through the super-resolution of multi-layer residual convolution neural network.

As shown in FIG. 8, the joint channel estimation and feedback method for user equipment and base station according to the embodiment of the present disclosure includes the following steps.

In step S801, the base station transmits downlink transmission data including a pilot signal to the user equipment. Thereafter, the process proceeds to step S802.

In step S802, the user equipment encodes the pilot signal into feedback channel state information, and transmits the feedback channel state information to the base station. Thereafter, the process proceeds to step S803.

In step S803, the base station receives uplink transmission data from the user equipment, and the uplink transmission data includes the feedback channel state information generated based on the pilot signal. Thereafter, the process proceeds to step S804.

In step S804, the base station decodes the feedback channel state information to obtain the channel matrix of the base station.

A decoding neural network and an encoding neural network are respectively configured in the base station 10 and the user equipment 20 of the joint channel estimation and feedback system 70 as described above. In order to configure the decoding neural network and the encoding neural network, it is necessary to perform joint network training for the base station 10 and the user equipment 20 of the joint channel estimation and feedback system 70. Hereinafter, a joint training device and a joint training method for performing joint network training will be further described.

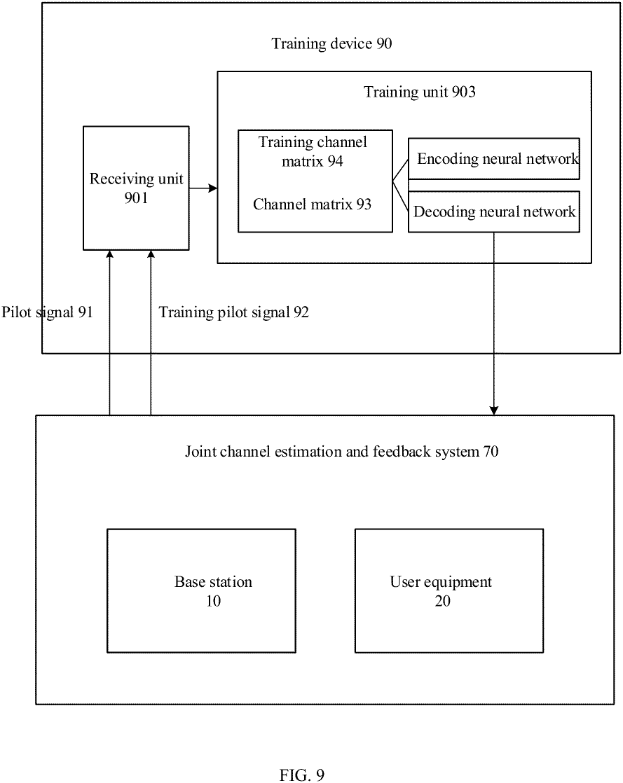

FIG. 9 is a block diagram illustrating a training device and its training joint channel estimation and feedback system according to an embodiment of the present disclosure. As shown in FIG. 9, the training device 90 includes a receiving unit 901 and a training unit 903.

The receiving unit 901 is configured to receive the pilot signal 91 and the training pilot signal 92 from the base station 10 in the joint channel estimation and feedback system 70. As mentioned above, the pilot signal 91 is usually a low-resolution part of the whole reference signal, that is, an incomplete reference signal. The training pilot signal 92 is a complete reference signal with high resolution.

The training unit 903 is used to encode the pilot signal into feedback channel state information by at least encoding neural network, and decode the feedback channel state information by at least decoding neural network to reconstruct the channel matrix 93 of the base station.

A training unit 903 acquires a training channel matrix 94 based on the training pilot signal 92, and the training unit 903 constructs a loss function based on the channel matrix 93 and the training channel matrix 94 to jointly train the encoding neural network and the decoding neural network. That is, the training channel matrix 94 acquired based on the training pilot signal 92 is a complete channel matrix, and the reconstructed channel matrix 93 needs to be close enough to the training channel matrix 94. When the difference between the channel matrix 93 and the training channel matrix 94 meets a predetermined condition, the training process can be ended. The trained encoding neural network can encode and compress the incomplete low-resolution reference signal, and the decoding neural network can reconstruct the complete channel matrix with super resolution.

The training unit 903 further outputs the trained parameters of the encoding neural network and the decoding neural network. Parameters of the encoding neural network and the decoding neural network can be further deployed to the user equipment and the base station respectively.

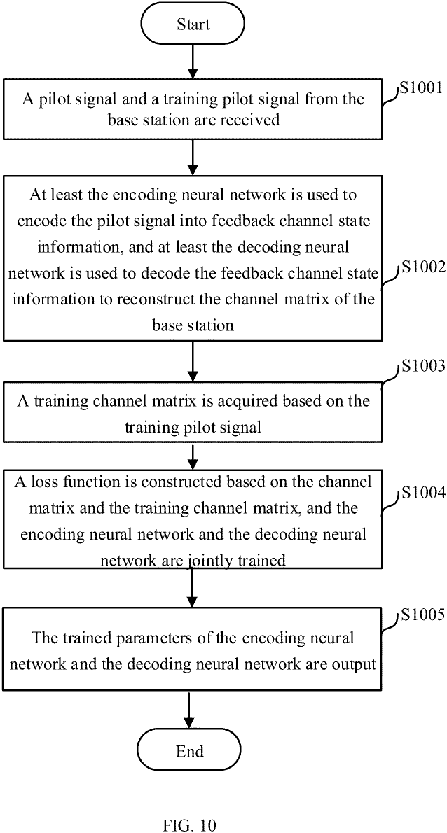

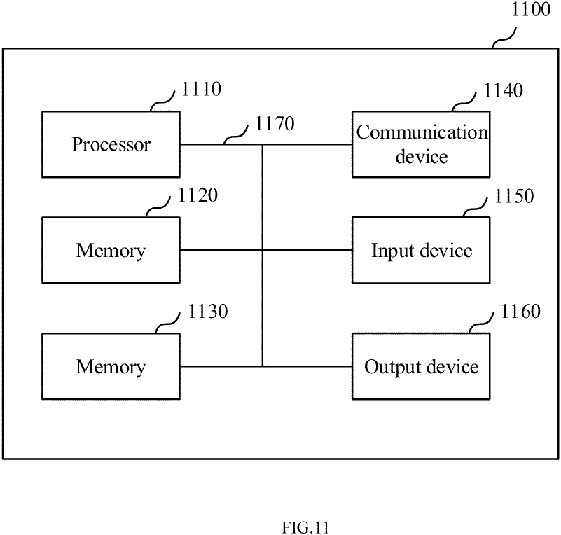

FIG. 10 is a flowchart illustrating a joint training method of user equipment and base station according to an embodiment of the present disclosure. The joint training method of user equipment and base station according to the embodiment of the present disclosure includes the following steps.

At step S1001, a pilot signal and a training pilot signal from the base station are received. Thereafter, the process proceeds to step S1002.

At step S1002, at least the encoding neural network is used to encode the pilot signal into feedback channel state information, and at least the decoding neural network is used to decode the feedback channel state information to reconstruct the channel matrix of the base station. Thereafter, the process proceeds to step S1003.

At step S1003, a training channel matrix is acquired based on the training pilot signal. Thereafter, the process proceeds to step S1004.

At step S1004, a loss function is constructed based on the channel matrix and the training channel matrix, and the encoding neural network and the decoding neural network are jointly trained. Thereafter, the process proceeds to step S1005.

At step S1005, the trained parameters of the encoding neural network and the decoding neural network are output. Parameters of the encoding neural network and the decoding neural network can be further deployed to the user equipment and the base station respectively.

According to the disclosed user equipment, base station, joint training equipment of user equipment and base station, joint channel estimation and feedback system of user equipment and base station, generation method of feedback channel state information executed by user equipment, generation method of channel matrix executed by base station, joint training method of user equipment and base station, and joint channel estimation and feedback method for user equipment and base station, the feedback channel state information is generated by user equipment according to actual pilot signals, and a deeper residual learning neural network is introduced into the base station. It is realized that the base station can reconstruct the completed high-resolution channel matrix even if the actually accepted pilot signal is an incomplete low-resolution part.

### Hardware Structure

In addition, the block diagram used in the description of the above embodiment shows blocks in units of functions. These functional blocks (structural units) are realized by any combination of hardware and/or software. In addition, the implementation means of each functional block is not particularly limited. That is, each functional block can be realized by one device that is physically and/or logically combined, or two or more devices that are physically and/or logically separated can be directly and/or indirectly (for example, by wired and/or wireless) connected to realize the above-mentioned multiple devices.

For example, a device of one embodiment of the present disclosure, such as a first communication device, a second communication device, or a flight user terminal, can function as a computer that executes the processing of the wireless communication method of the present disclosure. FIG. 11 is a schematic diagram of the hardware structure of a related device 1100 (base station or user equipment) according to an embodiment of the present disclosure. The above-mentioned device 1100 (base station or user equipment) can be configured as a computer device that physically includes a processor 1110, a memory 1120, a memory 1130, a communication device 1140, an input device 1150, an output device 1160, a bus 1170 and the like.

In addition, in the following description, the words “device” can be replaced by circuits, devices, units, etc. The hardware structure of the user and the base station may include one or more devices shown in the figure, or may not include some devices.

For example, only one processor 1110 is shown, but it may be a plurality of processors. In addition, the processing may be performed by one processor, or by more than one processor simultaneously, sequentially, or by other methods. In addition, the processor 1110 can be installed by more than one chip.

The functions of the device 1100 are realized, for example, by reading prescribed software (programs) into hardware such as the processor 1110 and the memory 1120, so that the processor 1110 performs operations, controls the communication by the communication device 1140, and controls the reading and/or writing of data in the memory 1120 and the memory 1130.

The processor 1110, for example, makes the operating system work to control the whole computer. The processor 810 may be composed of a Central Processing Unit (CPU) including interfaces with peripheral devices, control devices, arithmetic devices, registers, etc.

In addition, the processor 1110 reads out programs (program codes), software modules, data, etc. from the memory 1130 and/or the communication device 1140 to the memory 1120, and executes various processes according to them. As the program, a program that causes a computer to execute at least part of the actions described in the above embodiment can be adopted.

The memory 1120 is a computer-readable recording medium, for example, it can be composed of at least one of ROM, EPROM, EEPROM, RAM, and other suitable storage media. The memory 1120 can also be called a register, a cache, a main memory (main storage device), and the like. The memory 1120 can store executable programs (program codes), software modules, etc. for implementing the method according to an embodiment of the present disclosure.

The memory 1130 is a computer-readable recording medium, for example, it can be composed of a flexible disk, a floppy disk, a magneto-optical disk (for example, a compact disc ROM, etc.), a digital versatile disk, a Blu-ray, Registered trademark) optical disk), removable disk, hard disk drive, smart card, flash memory device (e.g., card, stick, key driver), magnetic stripe, database, server, and other suitable storage media. The memory 1130 may also be referred to as an auxiliary storage device.

The communication device 1140 is hardware (transmitting and receiving equipment) used to communicate between computers through wired and/or wireless networks, for example, it is also called network equipment, network controller, network card, communication module, etc. The communication device 1140 may include a high-frequency switch, a duplexer, a filter, a frequency synthesizer, etc. in order to realize, for example, Frequency Division Duplex (FDD) and/or Time Division Duplex (TDD). For example, the above-mentioned transmitting unit, receiving unit, etc. can be realized by the communication device 1140.

The input device 1150 is an input device (e.g., keyboard, mouse, microphone, switch, button, sensor, etc.) that accepts input from the outside. The output device 1160 is an output device (for example, a display, a speaker, a Light Emitting Diode (LED) lamp, etc.) that outputs to the outside. In addition, the input device 1150 and the output device 1160 may be an integrated structure (for example, a touch panel).

In addition, various devices such as the processor 1110 and the memory 1120 are connected by a bus 1170 for communicating information. The bus 1170 can be composed of a single bus or different buses between devices.

In addition, the base station and the user equipment may include a microprocessor, a Digital Signal Processor (DSP), an application specific integrated circuit (ASIC), a programmable logic device (PLD), Field Programmable Gate Array (FPGA) and other hardware, through which part or all of each functional block can be realized. For example, the processor 1110 can be installed by at least one of these hardware.

### (Variant)

In addition, the terms described in this specification and/or the terms required for understanding this specification can be interchanged with terms with the same or similar meanings. For example, channels and/or symbols can also be signals (signaling). In addition, the signal can also be a message. The reference signal can also be referred to as RS (Reference Signal) for short, and can also be called Pilot, pilot signal, etc. according to the applicable standard. In addition, Component Carrier (CC) can also be called cell, frequency carrier, carrier frequency, etc.

In addition, the information, parameters, etc. described in this specification may be expressed by absolute values, relative values to specified values, or other corresponding information. For example, wireless resources can be indicated by a prescribed index. Further, the formulas and the like using these parameters may also be different from those explicitly disclosed in this specification.

The names used for parameters and the like in this specification are not limiting in any way. For example, various channels (PUCCH (Physical Uplink Control Channel), PDCCH (Physical Downlink Control Channel), etc.) and information units can be identified by any appropriate names, so the various names assigned to these various channels and information units are not restrictive in any way.

The information, signals, etc. described in this specification can be represented by any of a variety of different technologies. For example, data, commands, instructions, information, signals, bits, symbols, chips, etc. that may be mentioned in all the above descriptions can be represented by voltages, currents, electromagnetic waves, magnetic fields or particles, optical fields or photons, or any combination thereof.

In addition, information, signals, etc. may be output from the upper layer to the lower layer and/or from the lower layer to the upper layer. Information, signals, etc. can be input or output via multiple network nodes.

Or the input and output information, signals, etc. can be stored in a specific place (such as memory) or managed through a management table. Or input information, signals, etc. can be covered, updated or supplemented. The output information, signals, etc. can be deleted. The input information, signals, etc. can be sent to other devices.

The information notification is not limited to the way/embodiment described in this specification, but can also be carried out by other methods. For example, the notification of information may be through physical layer signaling (e.g., downlink control information (DCI), uplink control information (UCI)), upper layer signaling (e.g., radio resource control (RRC)) signaling, broadcast information (master information block (MIB), system information block (SIB), medium access control (MAC) signaling), other signals or their combination.

In addition, the physical layer signaling can also be called L1/L2 (Layer 1/Layer 2) control information (L1/L2 control signal), L1 control information (L1 control signal), etc. In addition, RRC signaling can also be called RRC message, such as RRC Connection Setup message, RRC Connection Reconfiguration message, etc. In addition, the MAC signaling can be notified by a MAC control element (MAC CE), for example.

In addition, the notification of the prescribed information (for example, the notification of “X”) is not limited to explicit notification, but may also be performed implicitly (for example, by not notifying the prescribed information or by notifying other information).

The determination can be made by a value (0 or 1) represented by 1 bit, a true or false value (Boolean value) represented by true or false, or a comparison of numerical values (for example, with a specified value).

Whether software is called software, firmware, middleware, microcode, hardware description language or other names, it should be broadly interpreted as referring to commands, command sets, codes, code segments, program codes, programs, subroutines, software modules, applications, software applications, software packages, routines, subroutines, objects, executable files, execution threads, steps, functions, etc.

In addition, software, commands, information, etc. can be transmitted or received via a transmission medium. For example, when using wired technology (coaxial cable, optical cable, twisted pair, Digital Subscriber Line, etc.) and/or wireless technology (infrared, microwave, etc.) to transmit software from websites, servers, or other remote resources, these wired technologies and/or wireless technologies are included in the definition of transmission media.

The terms “system” and “network” used in this specification can be used interchangeably.

In this specification, the terms BS, radio Base Station, eNB, gNB, cell, sector, cell group, carrier and component carrier can be used interchangeably. Sometimes, the base station is also called by terms such as fixed station, eNodeB (eNB), access point, transmitting point, receiving point, femtocell, small cell, etc.

A base station can accommodate one or more (e.g., three) cells (also called sectors). When a base station accommodates a plurality of cells, the entire coverage area of the base station can be divided into a plurality of smaller areas, and each smaller area can also provide communication services through a base station subsystem (for example, indoor small base station (RRH, Remote Radio Head)). The term “cell” or “sector” refers to a part or the whole of the coverage area of the base station and/or base station subsystem that performs communication services in this coverage.

In this specification, the terms “Mobile Station”, “user terminal”, “User Equipment” and “terminal” can be used interchangeably. Mobile stations are sometimes referred to by those skilled in the art as subscriber stations, mobile units, subscriber units, wireless units, remote units, mobile devices, wireless devices, wireless communication devices, remote devices, mobile subscriber stations, access terminals, mobile terminals, wireless terminals, remote terminals, handsets, user agents, mobile clients, clients or some other appropriate terms.

In addition, the wireless base station in this specification can also be replaced by a user terminal. For example, the various modes/embodiments of the present disclosure can also be applied to the configuration in which the communication between the wireless base station and the user terminal is replaced by the communication between a plurality of user terminals (D2D). At this time, the functions of the first communication device or the second communication device in the above-mentioned device 800 can be regarded as the functions of the user terminal. In addition, words such as “up” and “down” can also be replaced by “side”. For example, the uplink channel can also be replaced by the side channel.

Similarly, the user terminal in this specification can also be replaced by a wireless base station. At this time, the functions of the above user terminal can be regarded as the functions of the first communication device or the second communication device.

In this specification, it is assumed that the specific operation performed by the base station may also be performed by its upper node according to the situation. Obviously, in a network composed of one or more network nodes with a base station, various actions for communication with terminals can be performed through the base station, more than one network node other than the base station (Mobility Management Entity (MME), Serving-Gateway (S-GW), etc. can be considered, but not limited to this), or their combination.

The modes/embodiments described in this specification can be used alone, in combination, or switched during execution. In addition, the processing steps, sequences, flow charts, etc. of each mode/embodiment described in this specification can be changed as long as there is no contradiction. For example, regarding the method described in this specification, various step units are given in an exemplary order, but not limited to the given specific order.

The modes/embodiments described in this specification can be applied to Long Term Evolution (LTE), LTE-A (LTE-Advanced), LTE-B (Beyond Long Term Evolution), LTE-Beyond), SUPER 3G, IMT-Advanced, 4th Generation Mobile Communication System (4G), 5th Generation Mobile Communication System (5G, Th generation mobile communication system), Future Radio Access (FRA), new Radio Access Technology (New-RAT), New Radio (NR), new radio access (NX, New radio access), Future generation radio access (FX), Global System for Mobile Communications (GSM (registered trademark), Global system for mobile communications), code division multiple access 3000(CDMA3000), ultra mobile broadband (UMB, Mobile Broadband), IEEE 920.11(Wi-Fi (registered trademark)), IEEE 920.16(WiMAX (registered trademark)), IEEE 920.20, UWB (Ultra-WideBand), Bluetooth (registered trademark), other suitable wireless communication methods, and/or systems extended based on them.

The record of “according to” used in this specification does not mean “only according to” as long as it is not explicitly stated in other paragraphs. In other words, records like “according to” refer to “only according to” and “at least according to”.

Any reference to units with names such as “first” and “second” used in this specification is not a comprehensive limitation on the number or order of these units. These names can be used in this specification as a convenient way to distinguish more than two units. Therefore, the reference of the first unit and the second unit does not mean that only two units can be used or that the first unit must precede the second unit in some forms.

The term “determining” used in this specification sometimes includes various actions. For example, regarding “determination”, calculation, calculation, processing, derivation, investigating, searching up (such as searching in tables, databases, or other data structures), ascertaining, and the like can be used. In addition, regarding “determination”, receiving (e.g., receiving information), transmitting (e.g., transmitting information), inputting, outputting, accessing (e.g., accessing data in memory), etc. can also be regarded as making “determination”. In addition, regarding “determination”, resolving, selecting, choosing, establishing, comparing, etc. can also be regarded as “determination”. That is to say, regarding “judgment (determination)”, several actions can be regarded as “judgment (determination)”.

As used in this specification, terms such as “connected” and “coupled” or any variation thereof refer to any direct or indirect connection or combination between two or more units, which may include the following situations: there are one or more intermediate units between two units that are “connected” or “coupled” with each other. The combination or connection between units can be physical, logical, or a combination of both. For example, “connect” can also be replaced with “access”. As used in this specification, it can be considered that two units are “connected” or “combined” with each other by using one or more wires, cables, and/or printed electrical connections, and as several non-limiting and non-exhaustive examples, by using electromagnetic energy with the wavelength of radio frequency region, microwave region, and/or light (both visible light and invisible light) region, etc.

When “including”, “including” and their variations are used in this specification or claims, these terms are as open as the term “having”. Further, the term “or” used in this specification or claims is not exclusive or.

The above disclosure has been described in detail, but it is obvious to those skilled in the art that the disclosure is not limited to the embodiments described in this specification. This disclosure can be implemented as modifications and changes without departing from the purpose and scope of this disclosure as determined by the claims. Therefore, the description of this specification is for the purpose of illustration, and does not have any restrictive meaning for this disclosure.

1. A user equipment, comprising:
a receiving unit for receiving downlink transmission data including a pilot signal from a base station;
an encoding unit for encoding the pilot signal into feedback channel state information; and
a transmitting unit for transmitting the feedback channel state information to the base station, wherein the base station reconstructs a channel matrix of the base station based on the feedback channel state information.

2. The user equipment according to claim 1, wherein the pilot signal is the pilot signal whose frequency is controlled by the base station.

3. The user equipment according to claim 1, wherein the encoding unit is configured with an encoding neural network, and the encoding neural network comprises at least one full connection layer for quantizing and compressing the pilot signal into a one-dimensional vector as the feedback channel state information.

4. A base station comprising:
a transmitting unit for transmitting downlink transmission data including a pilot signal to a user equipment;
a receiving unit for receiving uplink transmission data from the user equipment, wherein the uplink transmission data includes feedback channel state information generated based on the pilot signal; and
a decoding unit for decoding the feedback channel state information to obtain a channel matrix of the base station.

5. The base station according to claim 4, wherein the transmitting unit controls frequency of the pilot signal.

6. The base station according to claim 4, wherein the decoding unit is configured with a decoding neural network, and the decoding neural network at least comprises a multi-layer residual convolution neural network for super-resolution reconstructing the feedback channel state information into the channel matrix of the base station.

7-9. (canceled)

10. A channel matrix generation method executed by a base station, comprising:
transmitting downlink transmission data including a pilot signal to a user equipment;
receiving uplink transmission data from the user equipment, wherein the uplink transmission data comprises feedback channel state information generated based on the pilot signal; and
decoding the feedback channel state information to obtain a channel matrix of the base station.

11. (canceled)

12. (canceled)

13. The method according to claim 10, further comprising: controlling frequency of the pilot signal.

14. The method station according to claim 10, wherein decoding the feedback channel state information to obtain a channel matrix of the base station comprises:
super-resolution reconstructing the feedback channel state information into the channel matrix of the base station with a decoding neural network.
